(19) United States
(12) Patent Application Publication
(10) Pub. No.: US 2002/0156770 A1
(43) Pub. Date: Oct. 24, 2002

(54) System and method for marketing products

(76) Inventors: Philip S. Krichilsky, Charlotte, NC (US); Ramesh Narayanswammy, Huntersville, NC (US); Timothy Wells, Huntersville, NC (US)

Correspondence Address: Thomas M. Blasey, Esq., Hunton & Williams, Suite 1200, 1900 K Street, N.W., Washington, DC, 20006, US

(21) Appl. No.: 09/784,203

(22) Filed: Feb. 16, 2001

Related U.S. Application Data
(60) Provisional application No. 60/208,057, filed on May 31, 2000.

(51) Int. Cl. G06F 7/00; G06F 17/30; G06F 17/60

(52) U.S. Cl. 707/3; 705/26

(57) ABSTRACT

An order processing system for marketing products includes a processor, a memory, and a communication interface for interacting with at least one input station. The order processing system further includes a products database for storing product information and a search event database for storing search queries. The order processing system further includes processing functionality for performing processing functions, in conjunction with the processor and the memory. The processing functionality includes: logic for receiving a search query from a user, via the at least one input station, pertaining to a desired product; logic for processing the search query by making reference to the products database; logic for storing the search query in the search event database; logic for retrieving the search query from the search event database; and logic transmitting a message to the user based on the search query retrieved from the search event database. In one embodiment, the products comprise sealant-related and/or adhesive related products.

### CROSS REFERENCE TO RELATED APPLICATIONS

This application claims the benefit of U.S. Provisional Application No. 60/208,057, filed on May 31, 2000, which is incorporated herein by reference in its entirety.

### BACKGROUND OF THE INVENTION

The present invention generally relates to a system and method for marketing products. In a more specific embodiment, the present invention relates to a system and method for marketing sealant-related and/or adhesive-related products using an electronic shopping service.

The recent popularity of the Internet has spawned several “electronic shopping” systems. However, not all of these e-commerce ventures have been successful. For instance, some companies have launched systems that were directly modeled after their non-automated sales operations, but which failed to take into account considerations that are unique to the on-line environment. Other companies have launched services that were uniquely tailored to the on-line environment, but which overlooked time-honored principles of marketing. The continued difficulties encountered by many electronic shopping systems suggests that, in many cases, these problems are not easily overcome.

The amazon.com system exemplifies a shopping model employed by many electronic shopping systems. This system operates by prompting a user to specify key terms that characterize a desired product. The system responds by providing the user with a list of products that match the key terms. The user may then order one or more products from the list. The system places ordered products in an electronic shopping cart, allowing the user to purchase the products at a later point in time. After purchase, the system may prompt the user to consider purchasing additional related products. The system may automatically select these related products based on some relationship between the purchased product and the related products.

As appreciated by the present inventors, the above-described system may not fully exploit potential sales opportunities. For instance, the above-described system uses a generalized and formulaic approach to generating product recommendations. As a result of this generality, the recommendations may fail to satisfy the unique needs of different groups of users. Further, the automatic generation of recommendations based on product purchases does not serve to close a sale with a user who has performed a search, yet has declined to make a purchase.

A generalized and formulaic approach to marketing products may be especially ill-suited to certain technical fields that involve complex considerations. For instance, the selection of an appropriate adhesive-related product or sealant-related product requires the user to specify a complex set of product properties, and then select an appropriate product from a group of closely-related potentially suitable products. In this technical environment, the automatic generation of a recommendation using the above-described methodology may fail to accurately capture the user's product needs.

Accordingly, there is a need in the art to provide a more effective system and method for marketing products, and in a more particular embodiment, marketing adhesive-related and sealant-related products.

### BRIEF SUMMARY OF THE INVENTION

The disclosed technique solves the above-identified difficulties in known systems, as well as other unspecified deficiencies in the known systems.

According to one exemplary embodiment, the present invention pertains to an order processing system for marketing products, comprising a processor, a memory, and a communication interface for interacting with at least one input station. The order processing system further includes a products database for storing product information and a search event database for storing search queries. The order processing system further includes processing functionality for performing processing functions, in conjunction with the processor and the memory. The processing functionality, in turn, includes: logic for receiving a search query from a user, via the at least one input station, pertaining to a desired product; logic for processing the search query by making reference to the products database; logic for storing the search query in the search event database; logic for retrieving the search query from the search event database; and logic for transmitting a message to the user based on the search query retrieved from the search event database.

According to another exemplary embodiment, the products database contains information pertaining to sealant-related and/or adhesive-related products.

Other exemplary aspects of the invention pertain to: (a) a network-enabled system for marketing products; (b) a medium containing instructions for execution by a processor for carrying out a method for marketing products; and (c) a method for marketing products. These separate embodiments include features related to the embodiment describe above.

The inventions described above offer several advantages over known shopping systems. For instance, the use of the search event database enables a system administrator to apply highly accurate sales assistance to users, thus increasing the chances that the users will make a purchase using the shopping system (compared to known systems that do not maintain such intelligence regarding the users' search activities). Further, the search event database stores information pertaining to the users' prior searches even though these searches may not have culminated in sales. This enables the administrator to provide sales assistance to users that used the shopping system merely to browse through its products database. Further, in one embodiment, the routines rely, in part, on human analysis to assess the needs of users. This “human touch” further enhances the ability of the administrator to apply highly accurate sales assistance to users (compared to known systems which rigidly apply fully automatic and formulaic approaches in generating product recommendations).

Still further features and advantages of the present invention are identified in the ensuing description, with reference to the drawings identified below.

### BRIEF DESCRIPTION OF THE DRAWINGS

FIG. 1 shows an exemplary system for implementing the marketing technique of the present invention;

FIG. 2 shows an exemplary order processing system for use in the system of FIG. 1;

FIG. 3 shows an exemplary workstation for use in the system of FIG. 1;

FIGS. 4 and 5 show exemplary screen presentations for receiving search parameters from a user;

FIGS. 6A and 6B together show an exemplary screen presentation for displaying the contents of a search event database;

FIG. 7 shows an exemplary routine for investigating and acting on the contents of the search event database; and

FIG. 8 shows an exemplary routine for periodically communicating with users.

### DETAILED DESCRIPTION OF THE INVENTION

The invention relates to the marketing of products. In a general embodiment, the term “products” includes any type of goods that may be purchased for any reason. For instance, the term “products” may include goods purchased for personal consumer consumption, such as books, musical recordings, clothing, food products, etc. The term “products” may also include goods purchased primarily for business-related uses, such as raw materials, building materials, parts for machinery, etc.

In a more particular embodiment, which is emphasized in the following discussion, the term “products” refers to sealant-related products and/or adhesive-related products (collectively referred to as simply “sealants” for brevity and convenience). One type of sealant is used to join two types of materials together. Another type of sealant is primarily used to fill in openings (such as cracks or joints) in a single type of material. Another type of sealant is used primarily to coat a material. Still other applications of sealants may exist. Thus, the term “sealant” encompasses any substance which adheres to a material to perform any type of fastening or sealing function for any purpose.

The individuals requesting information regarding sealants typically include users that require such products for a business-related purpose. The individuals may work within respective industrial fields, and may be categorized on this basis. Exemplary industry-related fields include: electronics and telecommunications applications; glazing applications; maintenance and repair applications; marine applications; non-woven/hygiene applications; other construction applications; other industrial assembly applications; other packaging applications; transportation-related applications; window manufacturing applications; and woodworking applications. Other industry-related categories may be provided to cater to specific groups. Of course, the individuals requesting information regarding the sealants may also include users that are requesting such products for “personal” (e.g., home maintenance) purposes.

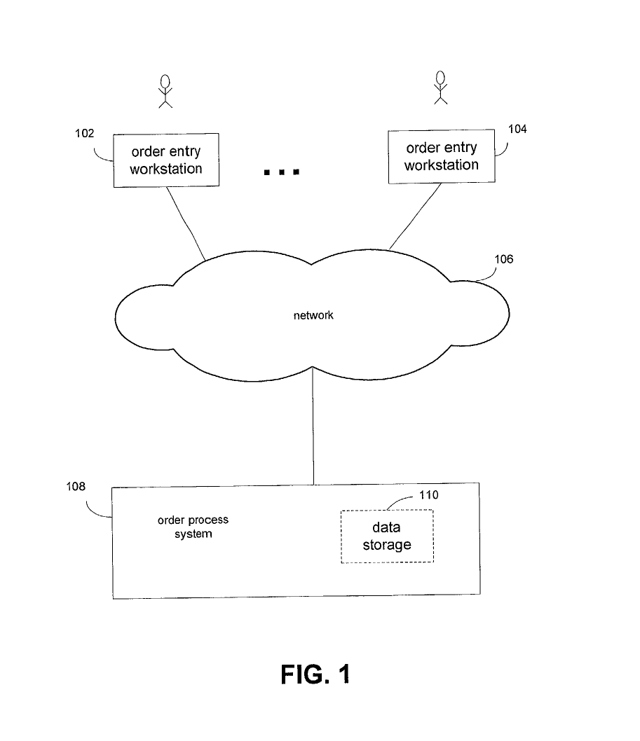

Now turning to the figures, FIG. 1 shows an overview of an electronic system that can be used to implement the present invention. The system includes an order processing system 108 coupled to one or more order entry workstations (e.g., workstations 102 and 104) via a network 106. The order processing system 108 also includes a data storage 110, which stores information pertaining to searchable and available products, as well as additional information.

The network 106 may comprise any type of local-area or wide-area network. For instance, the network 106 may be formed by an Internet connection, an intranet connection, a PAN (Personal Area Network), a LAN (Local Area Network), a WAN (Wide Area Network), a MAN (Metropolitan Area Network), a storage area network (SAN), etc. The network may further include wireless connection(s), such as a WAP (Wireless Application Protocol) link, a GPRS (General Packet Radio Service) link, a GSM (Global System for Mobile Communications) link, any type of spread spectrum or TDMA (Time Division Multiple Access) link, etc. The network 206 may operate using any type of network-enabled code, such as HyperText Markup Language (HTML), Dynamic HTML, Extensible Markup Language (XML), Extensible Stylesheet Language (XSL), Document Style Semantics and Specification Language (DSSSL), Cascading Style Sheets (CSS), etc.

In operation, shoppers may use respective workstations (e.g., workstations 102 and 104) to access the order processing system 108 via the network 106. In one embodiment, the workstations may gain access by inputting the address of an Internet website maintained by the order processing system 108. This allows the users to navigate through various screens provided by the website (to be discussed in greater detail below). In response to the users' queries, the order processing system 108 accesses and retrieves product-related information from the data storage 110.

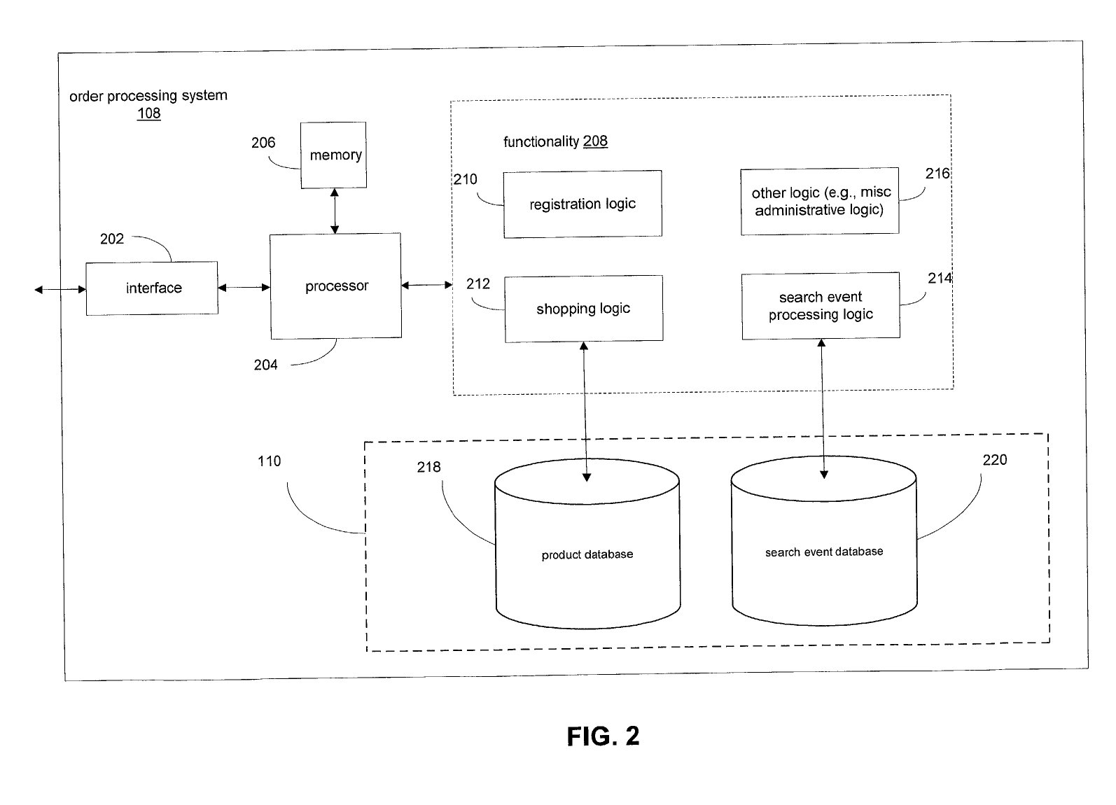

With reference to FIG. 2, the order processing system 108 includes conventional head-end processing components, including a processor 204 (such as a microprocessor), memory 206, cache (not shown), and interface 202. The processor 204 serves as a central engine for executing machine instructions. The memory 206 (such as a Random Access Memory, or RAM) serves the conventional role of storing program code and other information for use by the processor 204. The interface 202 serves the conventional role of interacting with external equipment, such as the workstations 102 and 104.

The data storage 110 of the order processing system 108 includes a product database 218 and a search event database 220. The product database 218 stores information regarding products that may be searched using the order processing system 108 (referred to as searchable products). In one embodiment, the order processing system 108 may permit users to directly order only a subset of searchable products using its services. In this case, the product database 218 also includes information that identifies the searchable products that are available for purchase (referred to as “available products”).

The search event database 220 stores information regarding searches input by users via their respective workstations. More specifically, the search event database 220 may store information regarding the identities of users that input searches, as well as the search terms specified in their respective searches.

Generally, the databases 218 and 220 may each comprise a single repository of information. Alternatively, the databases 218 and 220 may each comprise multiple repositories of information coupled to each other in a distributed fashion. Whatever organization is used, a variety of different database tools can be used to implement the databases, including the Oracle™ relational database sold commercially by Oracle Corp. Other database platforms, such as Informix™, DB2 (Database 2), Sybase, etc., may also be used.

The order processing system 108 may also comprise processing functionality 208. Such processing functionality 208 may represent machine-readable instructions for execution by the processor 204 for carrying out various functions. Such machine-readable instructions may be stored in any type of memory, such as magnetic media, CD ROM, etc.

The processing functionality 208 includes registration logic 210 for handling tasks involved in the registration of users. The processing functionality 208 may also include shopping logic 212 for processing the users' search queries by making reference to the product database 218. The processing functionality 208 may also include search event processing logic 214 for storing the users' search queries in the search event database 220. More specifically, the search event processing logic 214 may store information regarding the identities of users that input searches, as well as the search terms specified in their respective searches. The processing functionality 208 may also include additional processing logic 216 for performing other processing tasks involved in the administration of the shopping service.

The order processing system 108 may be implemented using various head-end architectures. For instance, the order processing system 108 may be implemented as a server (e.g., in the context of a client-server architecture). Such a server may be implemented using any one of various operating system platforms, such as Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an alternative embodiment, the order processing system 108 may be implemented using an architecture other than a client-server type architecture. For instance, the order processing system 108 may be implemented using a mainframe-type architecture.

In one embodiment, the order processing system 108 comprises a single computer. Alternatively, the order processing system 108 may comprise multiple computers connected together in a distributed fashion, each of which may implement/administer a separate aspect of the functions performed by the order processing system 108.

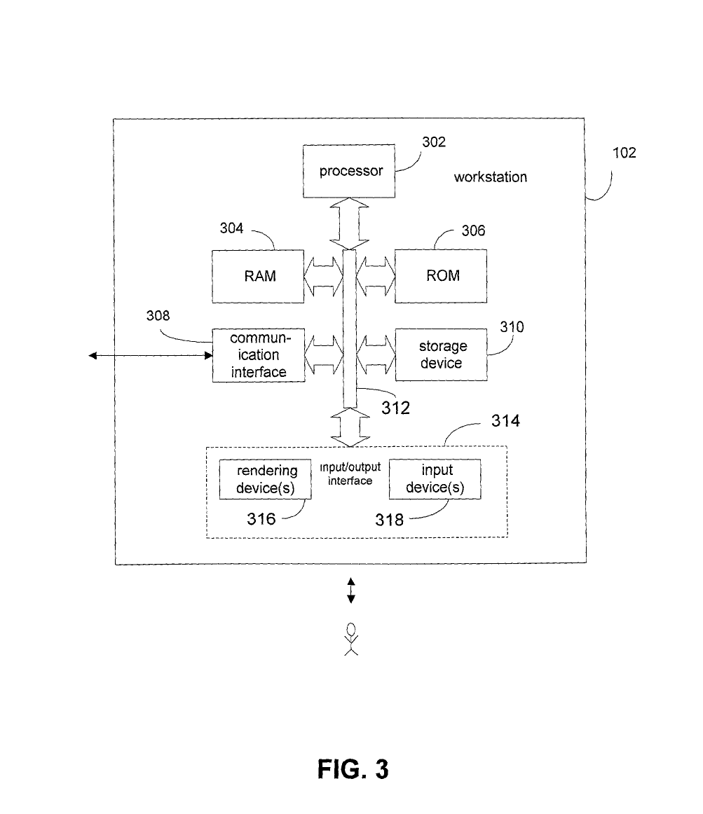

FIG. 3 shows an exemplary workstation (e.g., workstation 102) for interacting with the order processing system 108 of FIG. 2. The workstation 102 represents any type of general or special purpose computer comprising conventional hardware. Namely, the workstation 102 includes a processor 302 connected, via bus 312, to a Random Access Memory (RAM) 304, Read Only Memory (ROM) 306, and storage device 310 (such as a hard drive, CDROM, optical disc, etc.). The workstation 102 further includes an input/output interface unit 314, which, in turn, includes one or more devices 318 for inputting information (such as a keyboard, mouse-type input device, touch screen or panel, etc.), and one or more devices 316 for rendering information (including a display, printer, etc.). The workstation 102 also includes a communication interface device 308 (such as a modem, etc.) for interacting with external equipment (such as the order processing system 108) via the network 106. The workstation 102 may operate using any one of a variety of operating systems, such as the Microsoft Windows™ 98 program.

Other types of input devices can be used to interact with the order processing system 108, such as any type of handheld or wearable device (e.g., a Personal Digital Assistant, a cellular phone, etc.), or other type of device.

The order processing system 108 may supply a number of interface screens for presentation at the rendering device 316 of the workstation 102 in the course of a shopping session. For instance, the order processing system 108 may present an introductory (or “home”) interface screen (not shown) to the user in response to the user inputting a network address corresponding to the order processing system 108 via his or her workstation. The introductory screen may contain menu information that identifies various functions that the shopping service may perform. In conventional fashion, the introductory screen may include hypertext links “underlying” graphical depictions of the functions. By activating a link (e.g., using a mouse device to point to and “click on” the link), the user may activate its associated function.

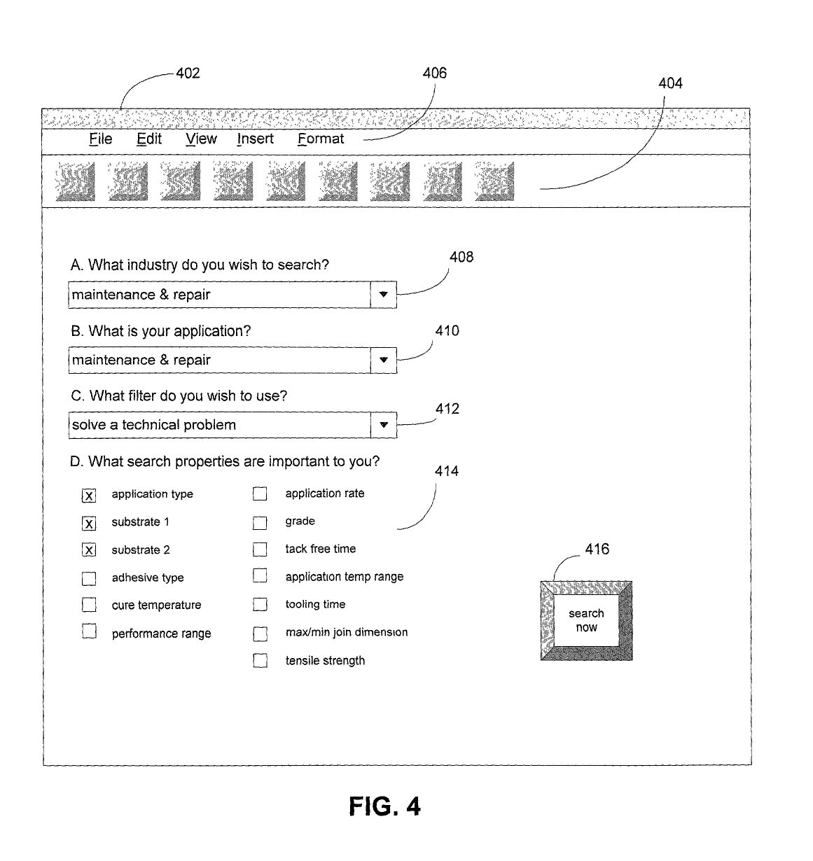

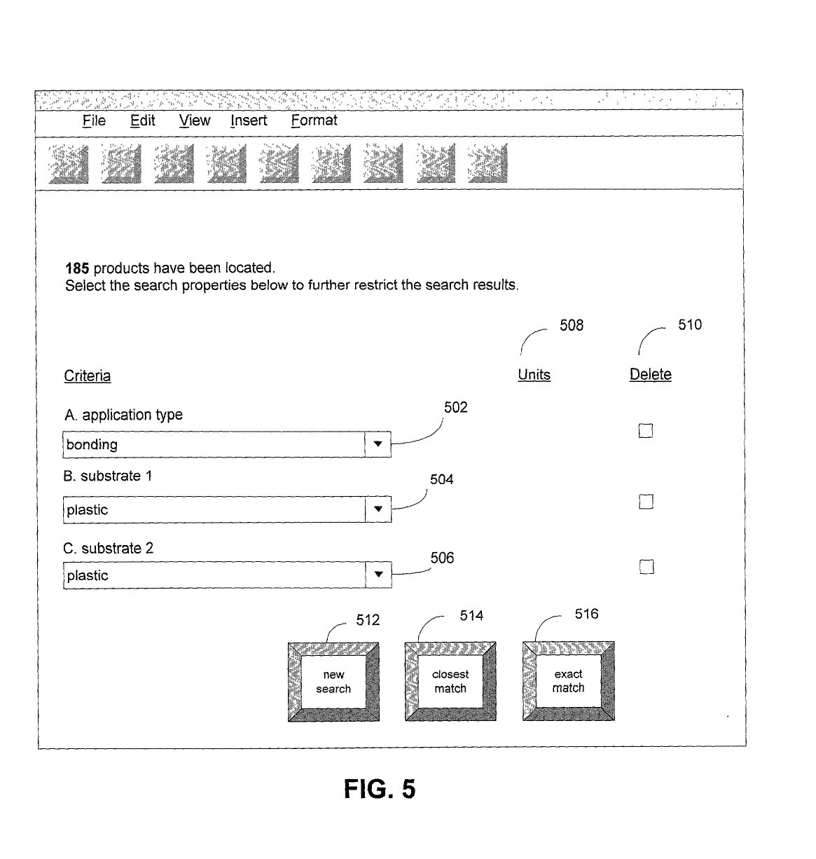

In response to the user activating a product search function, the order processing system 108 may present the search query input screen shown in FIG. 4, followed by the search query input screen shown in FIG. 5. With reference first to FIG. 4, this screen 402 includes conventional computer pull-down menus 406 (such as File, Edit, View, Insert, Format), as well as a tool bar 404 that may allow access to other functions that are specific to the product ordering system. Input box 408 includes a pull-down menu identifying industry-related selections. This input field is used to specify an industry associated with a user's search query. Exemplary industry-related categories include those identified above. To repeat, these categories include: electronics/telecommunications; glazing; maintenance and repair; marine; nonwoven hygiene; other construction; other industry assembly; packaging; transportation; window manufacturing; and woodworking. Those skilled in the art will appreciate that the order processing system 108 may include additional categories that may be appropriate in specific technical fields. In the example shown in FIG. 4, the user has selected the “maintenance & repair” category (e.g., by clicking on the appropriate entry in the pull-down menu).

Input box 410 includes a pull-down menu of application-related selections. This input field specifies the application associated with a user's search query. Exemplary application-related categories include: an all-inclusive category (e.g., specifying all applications); an adhesive/structural-related application; a bonding-related application; a filler-related application; a maintenance and repair related application; a splicing-related application; and a thread repair application. Those skilled in the art will appreciate that the order processing system 108 may include additional categories that may be appropriate to different technical fields. In the example shown in FIG. 4, the user has selected the “maintenance & repair” category (e.g., by clicking on the appropriate entry in the pull-down menu).

Input box 412 includes a pull-down menu of filter-related selections. This input field specifies various filters that may be applied to the search (which, in turn, governs the selectivity of the algorithm used to match a user's query with the database entries). Exemplary filter categories include: “solving a particular problem” (e.g., where a user aims to solve a particular technical problem); “finding a particular manufacturer” (e.g., where a user aims to restrict the search to specific manufacturers); “locating a specific product chemistry” (e.g., where a user aims to restrict the search to a specific chemical constitution); and “satisfying a particular technical criteria” (where a user intends to find a suitable sealant to satisfy a particular criteria). Those skilled in the art will appreciate that the order processing system 108 may include additional categories that may be appropriate to particular technical fields. In the example shown in FIG. 4, the user has selected the “solving a technical problem category” (e.g., by clicking on the appropriate entry in the pull-down menu).

Field 414 shown in FIG. 4 prompts the user to specify the search properties which are considered important in light of the user's searching objective. Table 1 identifies exemplary properties that may be displayed in field 414.

TABLE 1

| Property | Description |
|---|---|
| Adhesion | This property refers to the strength with which two |
| | bonded surfaces are held together with an adhesive, also |
| | known as the bond strength. Quantitative tests are |
| | available for measuring the adhesive strength under |
| | various environmental conditions. This property is |
| | measured in units such as psi. |
| Adhesive Type | This property identifies a cure system in terms of |
| | components (such as “one-component,” “two- |
| | component”). A two-component cure system operates |
| | by mixing two components together. A one-component |
| | system does not require the combination of two |
| | components. |
| Alias Name | This property identifies a name commonly used in an |
| | industry to refer to a product instead of the product's |
| | trade/product name (e.g., Loctite 3103 ™ is |
| | commercially referred to as Loctite Blue ™). |
| Application | This property refers to the rate at which a specific |
| Rate | amount of the product may be applied (e.g., in terms of |
| | quantity of mass per time). This property is particularly |
| | pertinent to extruding, spraying or squeeze-tube |
| | applications. |
| Application | This property refers to an optimum temperature at which |
| Temperature | the product will properly cure. |
| Range | |
| Application | This property refers to a non-specific explanation of |
| Type | applications for which the product is designed (such as |
| | sealing, bonding, coating, etc.). |
| Approvals | This property refers to third party approvals and ratings |
| | given to a product by organizations such as UL, FDA, |
| | and ASTM. |
| Cure | This property refers to the temperature at which the |
| Temperature | properties of a material change as a result of chemical |
| | reactions. It frequently involves a physical change from |
| | liquid to the solid state (often referred to as “hardening” |
| | or “setting”). Fully cured materials exhibit maximum |
| | physical, thermal and chemical properties in use. |
| Cure Type | This property defines the chemical process by which the |
| | material cures (such as room temperature cure, RTV |
| | cure, high temperature cure, etc.). |
| Dielectric | This property refers to the maximum voltage required to |
| Strength | produce a dielectric breakdown. |
| Dynamic Joint | This property refers to the percent of movement a |
| Movement | sealant can sustain. |
| Elongation % | This property refers to the amount in percent that a |
| | specimen can stretch before material break occurs. |
| Form | This property refers to pre-cure equilibrium state of a |
| | product, or how the material is supplied to the end-user |
| | (such as liquid, gel, paste, etc.) |
| Grade | This property identifies a material and is associated with |
| | a particular product name (such as Proglaze II ™, |
| | Spectrem 1 ™, Vulkem 202 ™, etc.). For example, in |
| | the last-cited sealant, the product name is “Vulkem,” |
| | and the product grade is “202.” |
| Manufacturer | This property indicates the organization that |
| | manufactures or supplies the material (such as GE |
| | Silicones, Tremco, Loctite, etc.). |
| Material | This property identifies the generic chemistry by which |
| | the particular product is manufactured (e.g., silicone, |
| | polyurethane, epoxy.) |
| Maximum/ | This property identifies the depth and width at which the |
| Minimum Joint | sealant is at its maximum/minimum design capability |
| Dimension | relating to movement. |
| Peel Adhesion | This property identifies an adhesive's resistance to being |
| | stripped from a bonded joint with the stripping force |
| | applied at a predetermined angle and rate. |
| Performance | This property refers to temperatures at which the |
| Range | sealant/adhesive will exhibit its optimal properties. |
| Product Name | This property identifies the name given to a line of |
| | materials by a manufacturer (such as Proglaze ™, |
| | Spectrem ™, Vulkem ™). |
| PSI Stress @ | This property defines the percent by which the cured |
| 50% Extension | product can be pulled. |
| Sag/Slump | This property defines a post-cure decrease in the |
| | thickness of a polymer section. |
| Shelf Life | This property defines the period of time a product can |
| | be stored without degrading or curing. |
| Substrate 1 | This parameter defines the surface upon which the |
| | adhesive is applied and to which it is expected to adhere |
| | (such as stainless steel, plastic, ceramic, etc.) |
| Substrate 2 | This parameters defines another surface upon which the |
| | adhesive is applied and to which it is expected to adhere |
| | (such stainless steel, plastic, ceramic, etc.). |
| Tack Free | This property refers to the time it takes a material to |
| Time | cure to the point of losing its immediate stickiness. |
| Tensile | This property defines the amount of force required to |
| Strength | break the material per unit area. |
| Tooling Time | This property refers to the time it takes a material to |
| | form a surface layer or skin. |

In the specific case of FIG. 4, the user is being prompted to identify which ones of the following parameters are considered important to his or her query: application type; substrate 1; substrate 2; adhesive type; cure temperature; performance range; application rate; grade; tack free time; application temperature range; tooling time; max/min joint dimension; and tensile strength. In this exemplary scenario, the user considers “application type,” “substrate 1” and “substrate 2” as important parameters, as indicated by the user's selection of these parameters. The user initiates the search thus defined by activating search icon 416 (“search now”).

Information presented in screen 402 may dynamically change as the user fills in information requested by this screen. For instance, the order processing system 108 may present different selections of properties in field 414 depending on the selections that the users makes in input boxes 408, 410 and/or 412. In another embodiment, a user's selection of an entry in a pull-down menu may cause the list of entries displayed in other pull-down menus (e.g., that have yet to be selected) to change. This dynamic self-populating feature is advantageous because it focuses the user's attention on search options that may be important to his or her objectives, without requiring the user to tediously sequence through many irrelevant menu items. The order processing system 108 may implement this feature by storing the various menu listings that may be presented by the system, as well as the input parameters which trigger the respective menu listings. Thus, when the user specifies one or more input parameters, the order processing system responds by accessing and displaying appropriate menu listings to guide subsequent entry of information.

The order processing system 108 next requests the user to input values for the parameters that were identified as “important” (e.g., via field 414 of FIG. 4). FIG. 5 shows an exemplary input screen for entering these values. As indicated there, the processing system 108 identifies that 185 products have been located that are relevant to the query specified thus far. To further narrow the search, the screen shown in FIG. 4 prompts the user to select specific values for the properties identified as being “important” in field 414 of FIG. 4.

More specifically, input box 502 includes a pull-down menu that allows a user to select values for the first property indicated as being “important,” namely application type. Exemplary application-related categories include: bonding; glazing; weather-stripping; sealant; coating; repellent; waterproofing; primer; encapsulating/potting/molding/grouting, etc. Those skilled in the art will appreciate that the order processing system 108 may include additional categories that may be appropriate to other technical fields. In the example shown in FIG. 5, the user has selected the “bonding” category (e.g., by clicking on the appropriate entry in the pull-down menu).

Input box 504 includes a pull-down menu that allows a user to select values for the second property indicated as being “important,” namely substrate 1 (i.e., a first substrate that the sealant is expected to adhere to.) Exemplary substrate-related categories include: plastic; glass; paper; wood; ceramic; composite; textile; various/other; rubber; masonry/stone; metal/alloys, etc. Those skilled in the art will appreciate that the order processing system 108 may include additional categories that may be appropriate to other technical fields. In the example shown in FIG. 5, the user has selected the “plastics” category (e.g., by clicking on the appropriate entry in the pull-down menu).

Input box 506 includes a pull-down menu that allows a user to select values for the third property indicated as being “important,” namely substrate 2 (i.e., a second substrate that the sealant is expected to adhere to). The exemplary substrate-related categories identified above with respect to the input box 504 apply here as well. In the example shown in FIG. 5, the user has again selected the “plastics” category (e.g., by clicking on the appropriate entry in the pull-down menu).

The screen shown in FIG. 5 also includes a “Units” field 508 for displaying any units that may be appropriate to the selected parameters. Further, the screen shown in FIG. 5 includes a “Delete” field 510. This field allows a user to remove one or more properties selected in field 414 of FIG. 4. Namely, to delete a property, the user points to and clicks on a box shown to the left of a corresponding search criteria property (e.g., using a mouse-type point and click device). This feature allows a user to broaden a search by removing search constraints. A user may find this tactic appropriate when he or she initially defines a search too narrowly, resulting in the retrieval of an inadequate number of search hits (or no hits at all). Instead of modifying the search, the user may start from “scratch” by activating the “new search” icon 512. Activating the “new search” icon 512 will allow the user to repeat the query-specification process.

When the user is satisfied with his or her search query as defined through the screens shown in FIGS. 4 and 5, the user activates the search by pressing either the closest match icon 514 or the exact match icon 516. The exact match icon identifies only products that exactly match the input search parameters. On the other hand, the closest match search icon 516 identifies products that most closely match the search parameters, but may not exactly match the search parameters. For instance, in the latter case, the order processing system 108 may initially attempt to identify the products that satisfy all of the selected search parameters. If an insufficient number of entries are found (e.g., if no entries are found), the order processing system may repeat the search by omitting one or more parameters.

The order processing system 108 responds by identifying a list of products that match the user's search terms, if any. The order processing system 108 then enables the user to compare the properties of selected products from the list, or order one or more products from the list. Upon selecting a product for order, the order processing system 108 determines whether the selected product is available. If so, the order processing system 108 permits the user to purchase the product. If the product is not available, the order processing system 108 determines whether other products exist that are potential substitutes for the selected product. If so, the order processing system 108 sends a message to the user that invites the user to purchase the substituted product (or products). The correlation of a selected unavailable product with substituted available products allows the system provider to realize various marketing objectives.

Additional details regarding the above-described shopping system are set forth in copending application Ser. No. 09/773,538, filed on Feb. 2, 2001, which is incorporated herein by reference in its entirety.

Regardless of whether the user purchases a product in a shopping session, the order processing system 108 stores information regarding the user's search in the search event storage database 220. More specifically, in one embodiment, the order processing system 108 stores at least the information specified in Table 2 in the database 220.

| Property | Description |
|---|---|
| industry | This field refers to the industry-affiliation of the |
| | user, e.g., as specified by the user when he or she |
| | subscribed to the shopping service. As indicated |
| | above, exemplary industry affiliations include: |
| | electronics/telecommunications; glazing; |
| | maintenance and repair; marine; nonwoven |
| | hygiene; other construction; other industry |
| | assembly; packaging; transportation; window |
| | manufacturing; and woodworking. |
| first name | This field refers to the first (given) name of the |
| | user, e.g., as specified by the user when he or she |
| | subscribed to the shopping service. |
| last name | This field refers to the second (family) name of the |
| | user, e.g., as specified by the user when he or she |
| | subscribed to the shopping service. |
| e-mail | This field refers to the e-mail address of the user, |
| | e.g., as specified by the user when he or she |
| | subscribed to the shopping service, and/or as |
| | gleaned from the order processing system's |
| | interaction with the user during one or more |
| | shopping sessions. |
| company | This field refers to the company that the user is |
| | affiliated with, e.g., as specified by the user when |
| | he or she subscribed to the shopping service. |
| date | This field refers to the date on which the search |
| | took place. |
| time | This field refers to the time at which the search |
| | took place. |
| searched industry | This field refers to the industry that the user |
| | specified in his or her search query, e.g. as |
| | specified in input box 408 in FIG. 4. As indicated |
| | above, exemplary industry entries may include: |
| | electronics/telecommunications; glazing; |
| | maintenance and repair; marine; nonwoven |
| | hygiene; other construction; other industry |
| | assembly; packaging; transportation; window |
| | manufacturing; and woodworking. |
| searched application | This field refers to the application that the user |
| | specified in his or her search query, e.g. as |
| | specified in input box 410 in FIG. 4. As indicated |
| | above, exemplary searched industry entries may |
| | include: an all-inclusive category (e.g., specifying |
| | all applications); an adhesive/structural-related |
| | application; a bonding-related application; a filler- |
| | related application; a maintenance and repair |
| | related application; a splicing-related application; |
| | and a thread repair application. |
| search type | This field refers to the filter that the user specified |
| | in his or her search query, e.g. as specified in input |
| | box 412 in FIG. 4. As indicated above, exemplary |
| | type entries may include: “solving a particular |
| | problem”; “finding a particular manufacturer”; |
| | “locating a specific product chemistry”; and |
| | “satisfying a particular technical criteria.” |
| criteria 1 | This field refers to a property that the user |
| | designated in his or her search query, e.g., as |
| | specified in input section 414 of FIG. 4. |
| criteria value 1 | This field refers to a first value that the user input |
| | for the above-identified “criteria 1,” e.g., as |
| | specified by the user through the screen shown in |
| | FIG. 5. |
| criteria value 2 | This field refers to a second value that the user |
| | input for the above-identified “criteria 1,” e.g., as |
| | specified by the user through the screen shown in |
| | FIG. 5. In one case, the first and second values |
| | (defined by “criteria value 1” and “criteria value |
| | 2”) specify an input range input by the user through |
| | the screen shown in FIG. 5. |
| UOM1 | This field refers to the unit of measure of the |
| | product that you are viewing. For example, most |
| | products are measured in “EACHES.” |

The order processing system 108 may restrict access to the database 220 to authorized administrative personnel (referred to below as “administrators” for brevity). The order processing system 108 may discriminate authorized from unauthorized users by comparing the users' input passwords against a file listing the passwords of authorized personnel.

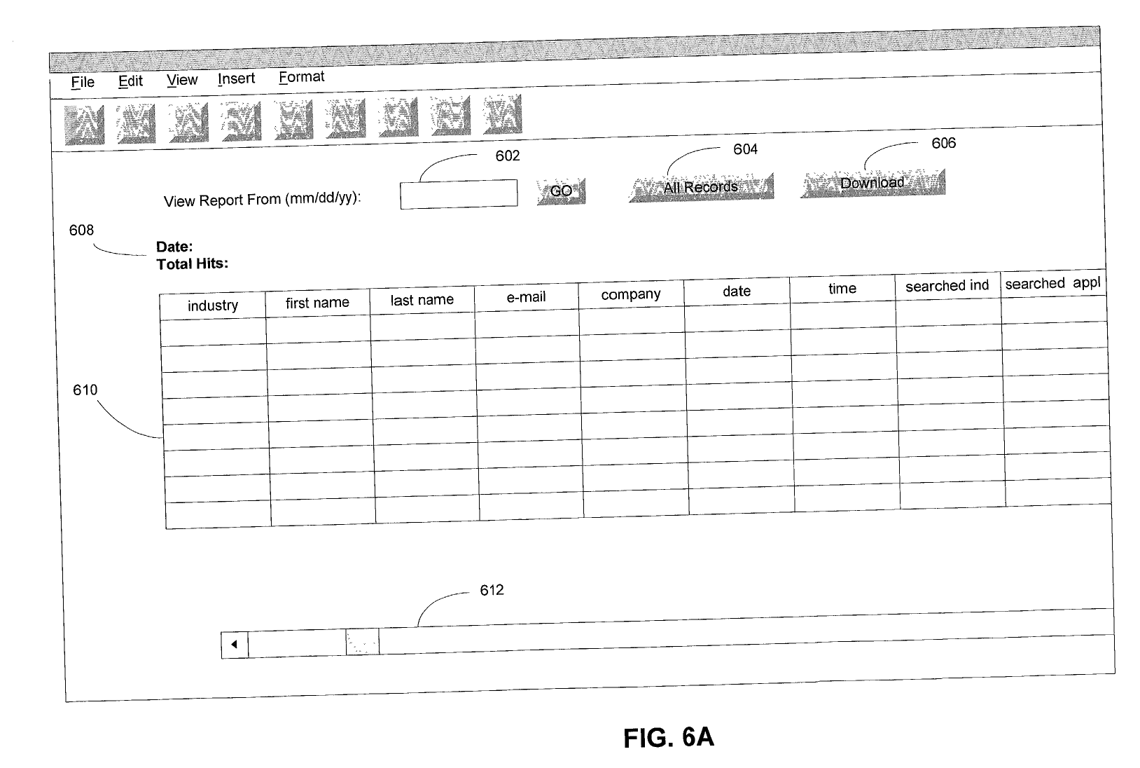

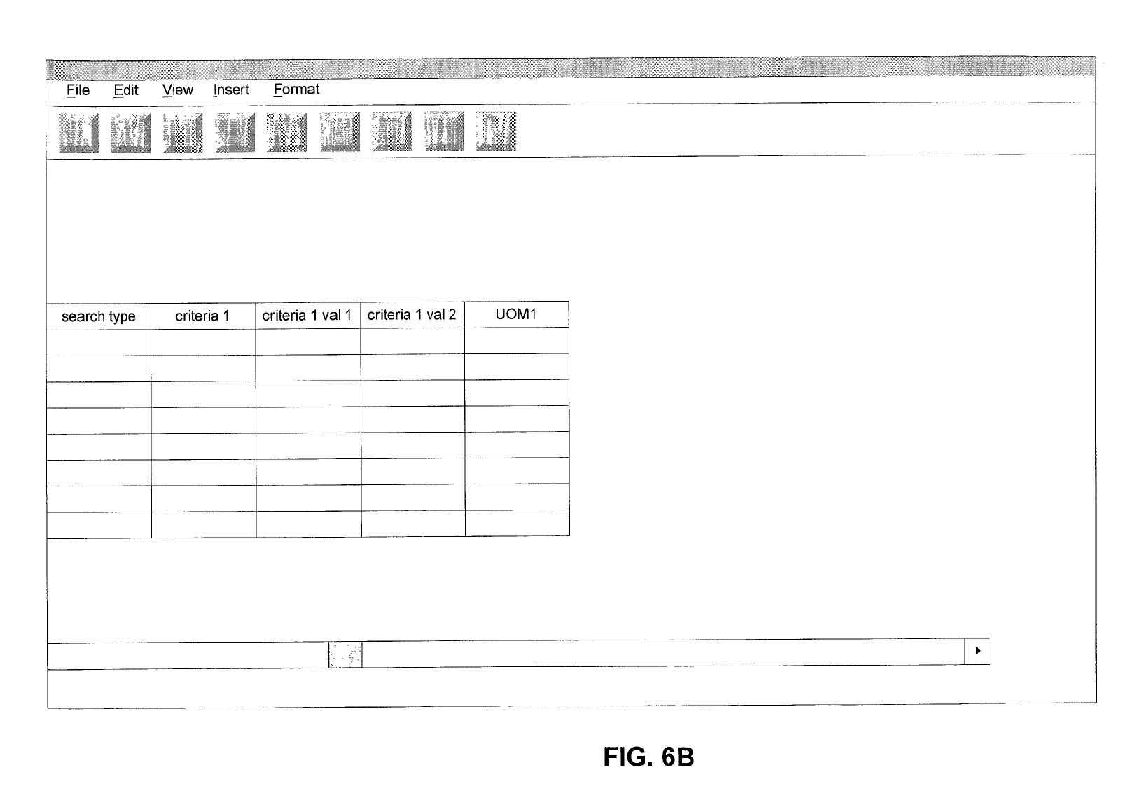

FIGS. 6A and 6B together represent one exemplary interface screen for use by an authorized administrator in retrieving information from the search event database 220. This screen includes an input field 602 that allows the administrator to specify a report date. Activation of a “GO” icon prompts the order processing system 108 to retrieve search queries made on the designated date. A table 610 presents the retrieved search queries. The fields presented in this table correspond to the parameters set forth in Table 2 above. Namely, the fields shown in FIG. 6A include “industry,” “first name,” “last name,” “e-mail,” “company,” “date,” “time,” “searched industry,” and “searched application.” The fields shown in FIG. 6B include “search type,” “criteria 1,” “criteria 1 val 1,” “criteria 1 val 2,” and “UOM1.” A conventional scroll bar 612 allows a user to slide the table 610 between the depictions shown in FIG. 6A and FIG. 6B. Field 608 provides confirmation of the retrieved date (“Date”), and an indication of the total number of searches (i.e., “Total Hits”) made on the designated date.

An icon 604 (“All Records”) allows an administrator to retrieve all search queries recorded within a prescribed reporting interval, such as within an entire week, month, or year, etc. Icon 604 (“Download”) permits an administrator to download files from the database 220 to the administrator's workstation in conventional fashion. The workstation may store the downloaded files in a local file (e.g., in storage device 310 of the workstation).

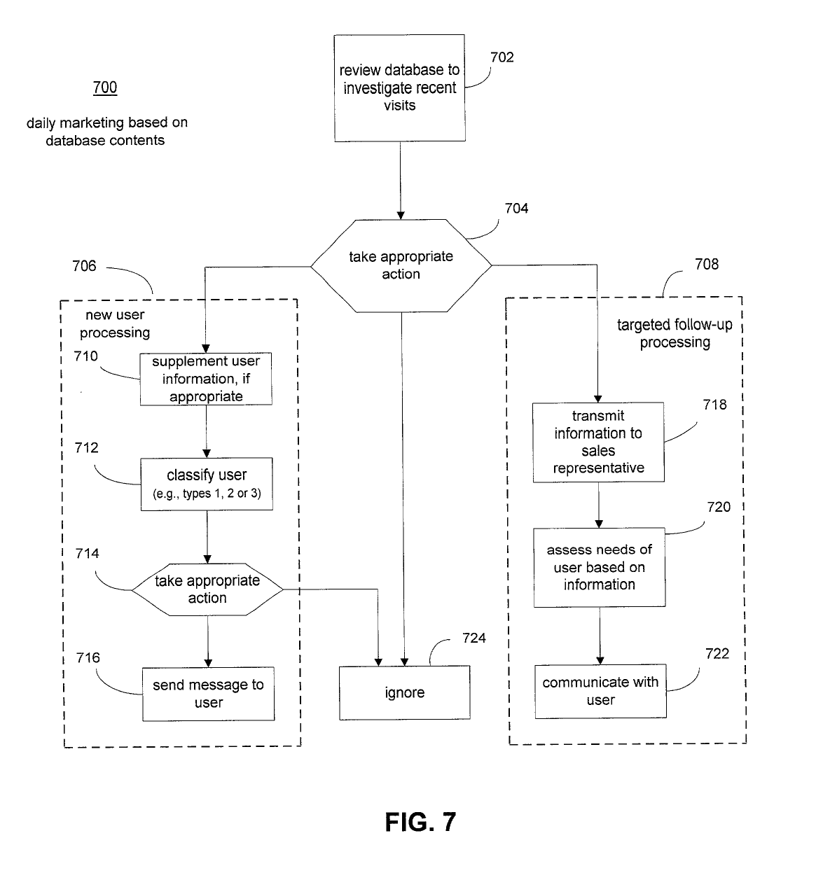

FIG. 7 identifies a procedure 700 for utilizing the information stored in database 220 to achieve a marketing objective. It begins in step 702, where the administrator accesses the database 220 via the interface screen shown in FIGS. 6A and 6B (or other database interface screen). More specifically, the administrator may retrieve search queries logged by the order processing system 108 within a prescribed period of time corresponding to a most recent reporting interval. For instance, the administrator may use the screen shown in FIGS. 6A and 6B to retrieve the queries logged by the order processing system 108 within the previous 24 hours (e.g., by specifying an appropriate date in input field 602).

Upon retrieving new search queries, the administrator takes appropriate action (as indicated in step 704). For instance, an administrator may perform a routine 706 when he or she determines that the search query under consideration was generated by a “new” user. The order processing system 108 may classify a user as “new” if the system has no prior record of the user accessing its services. Alternatively (or in addition), the administrator may perform routine 708 when he or she determines that the search query under consideration was generated by a user that may benefit from a personalized “follow-up” by a sales representative. In this case, the administrator instructs the sales representative to contact the user that generated the query so as to “close” a sale with the user. Still alternatively, the administrator may choose to simply ignore the search query (in step 724) when he or she determines that the search query under consideration does not represent a viable sales opportunity, and therefore does not warrant further attention. The following discussion describes each of these options in greater detail.

The new user processing routine 706 includes an initial step 710 of supplementing the search query under consideration with additional information. For instance, the administrator may attempt to gain additional information regarding the user that generated the search query. For instance, the administrator may use the user's e-mail address to identify the company that employs the user. The administrator may then retrieve and examine any Internet website sponsored by this company. The website may allow the administrator to determine the user's membership in one or more industrial categories (defined above), as well as other information that may have a bearing on the user's interests and needs. For example, the user may have expressly specified that he or she is affiliated with the aerospace industry. Nevertheless, the user's e-mail address may reveal that the user is affiliated with a company that specializes in some other field. Such intelligence allows the administrator to more accurately understand and satisfy the needs of its subscribers. The information collected regarding subscribers may be assembled to form profiles of the subscribers. The system 108 stores the profiles in a subscriber knowledge base (not shown).

In step 712, the administrator uses all available information to classify the user. In one classification scheme, if the administrator determines that the user represents a potential sales prospect, the administrator classifies the user as a “type 2” user. If the administrator determines that the user does not represent a potential sales prospect, the administrator classifies the user as a “type 3” user. And if the administrator is uncertain regarding whether the user represents a sales prospect (e.g., because of insufficient information regarding the user), the administrator classifies the user as a “type 1” user. In making this classification, the administrator may rely on a set of qualitative rules. Such rules may be expressed in a conventional “IF-THEN” format, e.g., “IF the user's profile satisfies condition X, THEN classify the user as type Y.” As those skilled in the art will appreciate, different service providers may devise different sets of rules that are tailored to their respective technical environments. Further, different service providers may devise different classification schemes that are tailored to their respective technical environments.

In step 714, the order processing system 108 takes appropriate action based on the classification defined in step 712. For instance, the order processing system 108 sends a introductory message to a type 2 user, welcoming that user to the shopping service. The order processing system 108 may send this message via e-mail to the user's electronic mailbox, or may send this message in some other fashion (e.g., via a physical mail service). The message may include general information regarding the shopping service. The message may further include a sales pitch. In one embodiment, the sales pitch may be specifically tailored to the user's industrial affiliation, e.g., inviting the user to purchase one or more products used in their industry. To further entice the new user, the message may offer a discount on the identified products.

The order processing system 108 may ignore a search query generated by a type 3 user. The order processing system may also ignore a search query generated by a type 1 user (who has indeterminate sales potential status), or alternatively, if so configured, may send this user a message designed to solicit further information from this user and/or to complete a sale with this user.

The order processing system 108 may update its subscriber knowledge base (not shown) when it gains additional information regarding its subscribers. Additional information may be gained through interaction with its subscribers in the course of multiple shopping sessions. For example, the order processing system 108 may reclassify the industrial affiliation of a user if it determines that its initial assessment was initially incorrect or non-optimal, or is now incorrect due to a change in the industrial affiliation of the user.

The targeted follow-up routine 708 aims to “close” a sale with a user that has been searching for a product using the shopping service provided by the order processing system 108. The routine beings in step 718, where the administrator transfers information regarding the user (and the user's logged search queries) to a sales representative. In one embodiment, the screen shown in FIGS. 6A and 6B may facilitate this task by providing a transfer button (not shown). Actuation of the transfer button causes the order processing system 108 to transfer information pertaining to the user (and the user's logged search queries) to a sales representative's workstation. Alternatively, the administrator may first download information to his or her workstation, and then transfer this information to the sales representative's terminal.

Upon receipt of the information, in step 720, the sales representative attempts to identify products that will satisfy the user's needs. In making this decision, the sales representative may access information regarding the user's profile, and may examine information concerning the nature of the user's search queries.

After analyzing the available information, the sales representative communicates with the user in step 722. The order processing system 108 may perform this communication by e-mail, or by some other method (such as by a physical mail service). The sales representative may specifically send the user a message which invites the user to purchase one or more identified products.

In an alternative embodiment (not shown), the sales representative may immediately contact the user (e.g., after receiving information concerning the user in step 718). The sales representative may then attempt to determine the needs of the user through an interactive dialogue with the user, and then generate a product recommendation as a culmination of this dialogue. Those skilled in the art will appreciate that still further sales techniques may be applied to close a sale with a potential sales prospect.

In a preferred embodiment, the routine 700 identified in FIG. 7 relies on human judgment to supplement information concerning the user (in step 710), to classify the user (in step 712), and to assess the needs of the user (in step 720). But the system automates other aspects of routine 700, such as the transmission of a message to the user subsequent to his or her classification (in step 716). In an alternative embodiment, the order processing system 108 may automate one or more of the above-identified human judgment steps. For instance, the order processing system 108 may include an artificial intelligence tool that is configured to mimic the thought processes used by the human evaluator in performing the manual evaluation tasks in routine 700. For instance, the order processing system 108 may include an expert system which performs human-like judgment, relying on a knowledge base of rules. The rules generally reflect the IF-THEN criteria used by the human administrator. In another alternative embodiment, the order processing system 108 may use a neural network to reproduce and automate the human judgement steps of the routine 700 shown in FIG. 7.

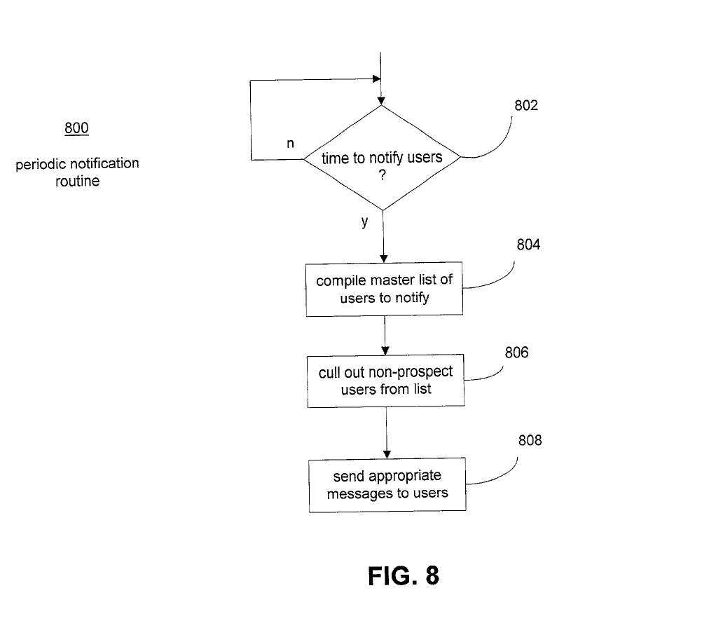

FIG. 8 identifies another routine 800 used to interact with the users on a periodic basis. More specifically, the order processing system 108 preferably performs this routine 800 every week, every month, biannually, and/or annually, etc. In step 802, the routine determines whether it is time to interact with the users. If so, in step 804, the routine compiles a master list of users that are to be notified. This step may entail extracting e-mail information stored in the search event database 220, as well as from other sources of user-related information. In step 806, the order processing system 108 processes the master list to remove entries corresponding to users that should not be notified for some reason. To perform this function, the order processing system 108 may compare the master list against another list that identifies users that should be not be notified (e.g., because it has been assessed that these users do not represent sales prospects). Then, in step 808, the order processing system 108 sends messages to the remaining users in the list. The order processing system 108 may perform this communication task via e-mail, via a physical mail service, or by some other communication technique.

The transmitted messages may contain general news information regarding the service, and/or information regarding the users' respective industries. The transmitted messages may also contain sales pitches. For example, the messages may contain offers that attempt to entice the users to purchase identified products. The system 108 may select the identified products to match up with the users' respective industrial affiliations.

In an alternative embodiment, the service provider may entrust a third party to interact with the users. In this case, the order processing system 108 forwards the list that identifies the users that should be notified to the third party, whereupon the third party notifies the users through one or more communication techniques (e.g., via e-mail, physical mail, or some other technique).

The routines described above offer several advantages compared to known shopping systems. For instance, the use of the search event database enables an administrator to apply highly accurate sales assistance to users, thus increasing the chances that the users will make purchases using the shopping system (compared to known systems that do not maintain such intelligence regarding the users' search activities). Further, the search event database provides information pertaining to the users' prior searches even though the searches may not have culminated in sales. This enables the administrator to provide sales assistance to users that used the shopping system merely to browse through its products database. Further, in one embodiment, the routines rely, in part, on human analysis to assess the needs of users. This “human touch” further enhances the ability of the administrator to apply highly accurate sales assistance to users (compared to known systems which apply fully automatic and formulaic approaches in generating product recommendations). Still further advantages will be recognized by those having skill in the art.

A number of additional features may be incorporated in the order processing system 108 to enhance the administrator's ability to assess the needs of its users. For instance, the order processing system 108 may organize its collected information into various statistical reports. For instance, the order processing system 108 may generate traffic reports. The traffic reports may identify the total number of users that have used the shopping service within a specified time frame (such as within a week, a month, and/or a year). The order processing system 108 may further discriminate the total number of users within particular industrial groups that have used the service within the specified time frame. In addition, the order processing system 108 may provide information which indicates the relative popularity of different services offered by the order processing system 108. For instance, the order processing system 108 may generate reports pertaining to: “Last Week's Top Pages”; “Last Month's Top Pages”; “Year-To-Date Top Pages,” etc.

Further, as indicated in the above-identified copending application, the order processing system 108 may accommodate different techniques for locating and ordering products, such as a “Quick Search” routine, etc. The order processing system 108 may also store search parameters that were input by users using these supplemental search techniques, allowing an administrator to provide appropriate sales assistance to the user on the basis of this stored information (in the manner described above).

Other modifications to the embodiments described above can be made without departing from the spirit and scope of the invention, as is intended to be encompassed by the following claims and their legal equivalents.

What is claimed is:

1. An order processing system for marketing products, comprising:
a processor;
a memory;
a communication interface for interacting with at least one input station;
a products database for storing information regarding products;
a search event database for storing information regarding search queries;
processing functionality for performing processing functions, in conjunction with the processor and the memory, including:
logic for receiving a search query from a user, via the at least one input station, pertaining to a desired product;
logic for processing the search query by making reference to the products database;
logic for storing the search query in the search event database;
logic for retrieving the search query from the search event database; and
logic for transmitting a message to the user based on the search query retrieved from the search event database.

2. The system of claim 1, wherein the products database contains information pertaining to sealant-related and/or adhesive-related products.

3. The system of claim 1, wherein the logic for receiving a search query is configured to receive multiple parameters defining a desired product.

4. The system of claim 1, wherein the logic for receiving a search query is configured to receive at least of the following search parameters:
an industry designation related to a topic of inquiry;
an application-related designation related to a topic of inquiry; and
an indication of a filter to be applied to the search query.

5. The system of claim 1, wherein the logic for storing the search query is configured to store multiple input parameters that define a desired product.

6. The system of claim 1, wherein the logic for transmitting is configured to transmit the message to a user if an administrator classifies the user as a potential sales prospect.

7. The system of claim 1, further including logic for forwarding the search query to a sales representative.

8. The system of claim 7, wherein the logic for transmitting is configured to transmit a message to a user based on analysis performed by the sales representative.

9. The system of claim 1, wherein the logic for transmitting is configured to transmit a message to the user on a periodic basis.

10. A network-enabled system for marketing products, comprising:
at least one input station;
a network;
an order processing system including:
a processor;
a memory;
a communication interface for interacting with the at least one input station via the network;
a products database for storing information regarding products;
a search event database for storing information regarding search queries;
processing functionality for performing processing functions, in conjunction with the processor and the memory, including:
logic for receiving a search query from a user, via the at least one input station, pertaining to a desired product;
logic for processing the search query by making reference to the products database;
logic for storing the search query in the search event database;
logic for retrieving the search query from the search event database; and
logic for transmitting a message to the user based on the search query retrieved from search event database.

11. A medium containing instructions for execution by a processor for carrying out a method for marketing products, comprising:
logic for receiving a search query from a user pertaining to a desired product;
logic for processing the search query by making reference to a products database;
logic for storing the search query in a search event database;
logic for retrieving the search query from the search event database; and
logic transmitting a message to the user based on the search query retrieved from search event database.

12. A method for marketing products, comprising:
receiving a search query from a user pertaining to a desired product;
processing the search query by making reference to a products database;
storing the search query in a search event database;
retrieving the search query from the search event database; and
transmitting a message to the user based on the search query retrieved from the search event database.

13. The method of claim 12, wherein the database contains information pertaining to sealant-related and/or adhesive-related products.

14. The method of claim 12, wherein the step of receiving a search query includes receiving multiple parameters defining a desired product.

15. The method of claim 12, wherein the step of receiving a search query includes at least one of the following search parameters:
an industry designation related to a topic of inquiry;
an application-related designation related to a topic of inquiry; and
an indication of a filter to be applied to the search query.

16. The method of claim 12, wherein the step of storing the search query includes storing multiple input parameters that define a desired product.

17. The method of claim 12, further including the step of determining, by a human administrator, whether the user is a potential sales prospect, and wherein the step of transmitting includes transmitting the message to the user if the administrator classifies the user as a potential sales prospect.

18. The method of claim 17, wherein the message identifies at least one product for purchase by the user at a stated discount.

19. The method of claim 12, further including the step of forwarding the retrieved search query to a sales representative.

20. The method of claim 19, further including the step, performed by the sales representative, of performing analysis based on the search event, wherein the step of transmitting includes transmitting a message to a user based on the analysis performed by the sales representative.

21. The method of claim 12, where the step of transmitting includes transmitting a message to the user on a periodic basis.

22. A processor readable medium for providing instructions to at least one processor for directing the at least one processor to perform the method recited in claim 12.

23. A computer signal embodied in a carrier wave readable by a computing system and encoding a computer program of instructions for executing a computer process performing the method recited in claim 12.

24. A method for marketing products, comprising:
receiving a search query from a user pertaining to a desired product;
processing the search query by making reference to a products database;
storing the search query in a search event database;
retrieving the search query from the search event database;
performing at least one of procedures A and B,
wherein procedure A comprises:
A(1) generating information regarding the user that input the search query;
A(2) classifying the user as either a sales prospect or a non-sales prospect;
A(3) transmitting a message to the user if the user is assessed as a sales prospect,
and wherein procedure B comprises:
B(1) forwarding the search query to a sales representative;
B(2) assessing, by the sales representative, the product needs of the user; and
B(3) transmitting a message to the user based on the assessed product needs of the user.

25. The method of claim 24, wherein the step of storing the search query includes storing multiple input parameters that define a desired product.
